(19) United States
(12) Patent Application Publication
(10) Pub. No.: US 2019/0120965 A1
(43) Pub. Date: Apr. 25, 2019

(54) METHOD AND SYSTEM OF DIGITAL LIGHT PROCESSING AND LIGHT DETECTION AND RANGING FOR GUIDED AUTONOMOUS VEHICLES

(71) Applicant: BAE SYSTEMS Information and Electronic Systems Integration Inc., Nashua, NH (US)

(72) Inventor: Michael J. CHOINIERE, Merrimack, NH (US)

(21) Appl. No.: 15/793,111

(22) Filed: Oct. 25, 2017

(51) Int. Cl. G01S 17/89; G01S 17/06; G06T 17/05; G05D 1/00

(52) U.S. Cl. CPC G01S 17/89; G01S 17/06; G06T 2207/30252; G05D 1/0088; G06T 17/05

(57) ABSTRACT

The system and method of guiding an autonomous vehicle and/or mapping a target in 3D space using a digital light processing array and a laser with a wide field of view. The variability of the digital light processing array allows for adjustment of image resolution to account for range, weather conditions, and attitude of the target. Coupled with a learning AI system, an unmanned vehicle can offer superior tactical flexibility in the operational environment.

### FIELD OF THE DISCLOSURE

The present disclosure relates to guidance systems of unmanned vehicles and more particularly to the use of digital light processing (DLP) and light detection and ranging (LiDAR) to guide unmanned vehicles.

### BACKGROUND OF THE DISCLOSURE

3D LIDARs typically uses a laser with a very narrow beam divergence to scan the topography and then collects the return energy using a wide FOV receiver. In conventional systems, the spatial filter is the laser itself; radiating only a small portion of the scene for a single range determination. By using a high pulse repetition frequency (PRF) laser and a fast scanner a 3D image is generated. The cost of the scanning laser, both the laser and scanner tends be costly and require several moving components while yielding lower reliability.

### SUMMARY OF THE DISCLOSURE

One aspect of the present disclosure is A digital light processing and light detection and ranging system for guiding autonomous vehicles, comprising a laser transmitter for transmitting a laser pulse having a field of view; a digital light processing array having a plurality of micro-mirrors, and each of the plurality of micro-mirrors having both an on position and an off position, wherein the micro-mirrors are in the on position when they receive laser light reflected back from an object; a detector element for receiving light reflected by the plurality of micro-mirrors of the digital light processing array when the plurality of micro-mirrors are in the on position; an optical condenser arrangement located between the digital light processing array and the detector element; an analog/digital converter coupled to the detector element for processing signals detected by the detector element; and a navigation processor configured to assess the terrain roughness, the terrain complexity and the terrain depth to determine the best course given limits of the autonomous vehicle.

One embodiment of the digital light processing and light detection and ranging system for guiding autonomous vehicles is wherein the laser pulse comprises visible, near infrared, and short wave infrared bands radiating between 0.5 and 30 KHz.

In some cases, the laser pulse operates at 5 to 100 μJ. In certain embodiments, the field of view of the laser ranges from about 2 degrees to about 70 degrees.

In another embodiment of the digital light processing and light detection and ranging system for guiding autonomous vehicles, the digital light processing array ranges from video graphics array format to high definition format and operates from 0.5 to 30 KHz in the visible, near infrared, and/or short wave infrared bands.

In some cases, the autonomous vehicle is selected from the group consisting of ground, air, or marine.

Another aspect of the present disclosure is a method of intermixing line scans and complex geometry mapping for use with spatial filtering and time interlacing to produce both near and far sampling over a scene of interest using decomposition and reconstruction, comprising providing a digital light processing and light detection and ranging system, comprising a laser transmitter for transmitting a laser pulse having a field of view; a digital light processing array having a plurality of micro-mirrors, and each of the plurality of micro-mirrors having both an on position and an off position, wherein the micro-mirrors are in the on position when they receive laser light reflected back from an object; a detector element for receiving light reflected by the plurality of micro-mirrors of the digital light processing array when the plurality of micro-mirrors are in the on position; an optical condenser arrangement located between the digital light processing array and the detector element; an analog/digital converter coupled to the detector element for processing signals detected by the detector element; and a navigation processor configured to assess the terrain roughness, the terrain complexity, and the terrain depth to determine the best course given the limits of an autonomous vehicle; transmitting laser light, via the laser, onto a scene; receiving laser light reflected back from the scene, via the digital light processing array using one or more horizontal line scans to determine the image roughness and relative distances; adapting, via the processor, the digital light processing array scanning pattern to add detail in areas of complexity and relative proximity to the autonomous vehicle; intermixing, via the processor, the horizontal line scans and area concentration mapping, as needed, to collect terrain data for the particular vehicle mission; and feeding the collected terrain data to the autonomous vehicle for use in navigation of the scene.

One embodiment of the method for guiding autonomous vehicles is wherein the laser pulse comprises visible, near infrared, and/or short wave infrared bands radiating between 0.5 to 30 KHz. In some cases, the laser pulse operates at 5 to 100 μJ.

In another embodiment, the field of view ranges from about 2 degrees to about 70 degrees.

In some cases, the digital light processing array ranges from video graphics array format to high definition format and operates from 0.5 to 30 KHz in the visible, near infrared and/or short wave infrared bands.

In certain embodiments, the autonomous vehicle is selected form the group consisting of ground, air, and marine.

Yet another aspect of the present disclosure is a method of identifying targets by measuring a target depth in 3D space, comprising transmitting laser light, via a laser, onto a scene at a field of view of about 40 to 60 degrees; receiving laser light reflected back from the scene, via a digital light processing array using one or more horizontal line scans to determine an image roughness and relative distance; adapting, via a processor, the digital light processing array scanning pattern to add detail in areas of complexity and relative proximity to an autonomous vehicle; intermixing, via the processor, the horizontal line scans and area concentration mapping to create a 3D virtual image of a target; and feeding the 3D virtual image of the target to a user for use in tactical applications.

One embodiment of the method of identifying targets is wherein the laser pulse comprises visible, near infrared, and/or short wave infrared bands radiating between 0.5 and 30 KHz.

In some cases, the laser pulse operates at 5 to 100 μJ. In certain embodiments, the field of view ranges from about 2 degrees to about 70 degrees.

In another embodiment of the method of identifying targets, the digital light processing array ranges from video graphics array format to high definition format and operates from 0.5 to 30 KHz in the visible, near infrared and/or short wave infrared bands.

In some cases, the autonomous vehicle is selected from the group consisting of ground, air, and marine.

These aspects of the disclosure are not meant to be exclusive and other features, aspects, and advantages of the present disclosure will be readily apparent to those of ordinary skill in the art when read in conjunction with the following description, appended claims, and accompanying drawings.

### BRIEF DESCRIPTION OF THE DRAWINGS

The foregoing and other objects, features, and advantages of the disclosure will be apparent from the following description of particular embodiments of the disclosure, as illustrated in the accompanying drawings in which like reference characters refer to the same parts throughout the different views. The drawings are not necessarily to scale, emphasis instead being placed upon illustrating the principles of the disclosure.

FIG. 1 shows one embodiment of the present disclosure used in a short range application.

FIG. 2 shows one embodiment of the present disclosure used in a long range application.

FIG. 3 shows resolution changes with ranges according to the principles of the present disclosure.

FIG. 4 is a diagrammatic view of one embodiment of the system of the present disclosure.

FIG. 5 is a diagram of one embodiment of a method of the present disclosure.

FIG. 6 is a flow chart of one embodiment of a method of the present disclosure.

### DETAILED DESCRIPTION OF THE DISCLOSURE

The conventional approach to generate a 3D virtual image uses a narrow laser and a scanner to position the laser at the next data point within the FOV to measure the distance. This process continues one point at a time until the region of interest is mapped. This approach requires a laser with good beam quality and an optical scanner.

In contrast, the present disclosure utilizes a scanning laser with a wide field of view (FOV) and a digital light processing mirror to limit a receiver's field of view (FOV) into smaller, variable spatial filters. The laser generates a large FOV area pulse (strobe light effect) and the receiver only samples the area of interest for the range determination. By reversing the conventional methodology, the present system eliminates cost, complexity, and the size of the LIDAR. In one embodiment, a wide angle beam (e.g., 40°-60° FOV) laser pulse is used which covers the entire scene and spatially modulates the return pulse through a digital light processing (DLP) mirror array.

The DLP mirror operates as a spatial scanner limiting what the receiver can see at any given pulse. Binary patterns can be loaded at about 3 to 10 KHz. The 3 KHz DLP mirror can vary the Azimuth and Elevation angle and the resolution by varying the number of pixels used in the limiting aperture. In one embodiment, the DLP mirror provides variable attenuation that increases or decreases the number of pixels that are left on.

For an unmanned vehicle, this approach can yield about 3000 data field points/sec of the terrain in front of the vehicle. The present disclosure allows spatial scanning with zero inertial impact from the scanner, thereby doing interlace angle scanning based on need rather than where the scanner was a moment ago. In some cases, any new field point within 0.0003 seconds corresponds to one DLP frame.

Certain embodiments of the present disclosure provide a very low cost, very small guidance system (e.g., 2 in³) with no moving parts and no inertia consideration for the scanner. In some cases, the system has complete flexibility for a dynamic and changing environment using any scan pattern. In some cases, the system is ideal for ground based vehicles/drones. In some cases, the system is useful for landing drones, 3D mapping, ground vehicle navigation, and the like. Certain embodiments of the system of the present disclosure contain no moving optical parts while having complete flexibility to project any scan pattern. In one such example horizontal scans are used in one portion of the DLP array and object tracking is used in a different portion of the array.

One embodiment of the system of the present disclosure is a surveying tool for generating 3D information at 5 to 10 KHz data rates. The system is limited by the particular laser employed for both speed and accuracy. In some cases, the system can be applied in surveying rooms, caves, open areas, or the like. The system's ability to adjust the scanning approach via a learning algorithm can bridge from scanning line by line to scanning by spot, or the like. In some cases, the choice of method is based on the particular need for information and the particular environment.

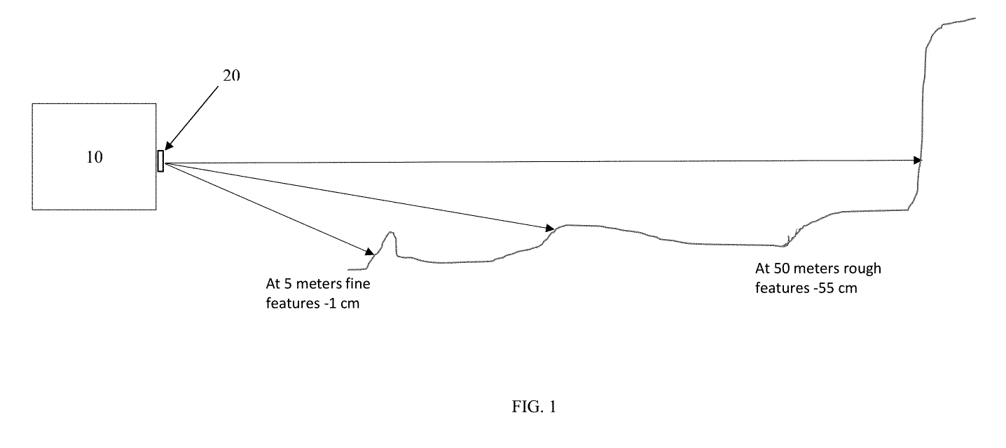

Referring to FIG. 1, one embodiment of the present disclosure used in a short range application is shown. More specifically, traditional mapping approaches scan the scene with the laser, but this approach scans the receiver. In some embodiments, the scan rates are about 3K to 10K pulse/second. The DLP scanning provides variable resolution vs depth. In one embodiment, one pulse covers the entire FOV (e.g., 40° to 60°). The DLP mirror then selects the direction and the amount of resolution, with no moving parts. This methodology provides for interlaced scanning “on the fly” and is useful for short, medium, and long range applications.

Still referring to FIG. 1, an unmanned vehicle 10 is guided by one embodiment of the system of the present disclosure 20 to navigate within the field. In some cases, the unmanned vehicle is an aerial vehicle, such as a drone, a space craft, or an unmanned vehicle navigating on land, on the surface of the water, or even underwater. In this figure, an unmanned vehicle is navigating on land and is able to process finer detail at a shorter range where the additional detail is needed to safely navigate the area while using lower resolution at father distances where gross features are adequate. In one embodiment, at 5 meters the features can be resolved to about 1 cm and at 50 meters the features can be resolved to about 55 cm. In one embodiment, the FOV provided by the laser is about 40 degrees at greater than 50 meters.

In one embodiment, a laser having a 50 μJ pulse is used and is distributed over the entire field of view (e.g., 40 to 60 degrees). In some embodiments, the DLP array comprises about 850×480 pixels and provides 410K resolution. See, for example, Table 1 using a 40 degree field of view:

TABLE 1
40 degree FOV

| | | | | spatial |
|---|---|---|---|---|
| | | linear resolution | angular resolution | resolution |
| Range (m) | data points | (m) | (mrads) | (cm) |
| 50 | 4000 | 63 | 11 | 55 |
| 40 | 6000 | 77 | 9 | 36 |
| 30 | 11000 | 105 | 7 | 20 |
| 20 | 25000 | 158 | 4 | 9 |
| 10 | 100000 | 316 | 2.2 | 2.2 |
| 5 | 200000 | 447 | 1.6 | 0.8 |

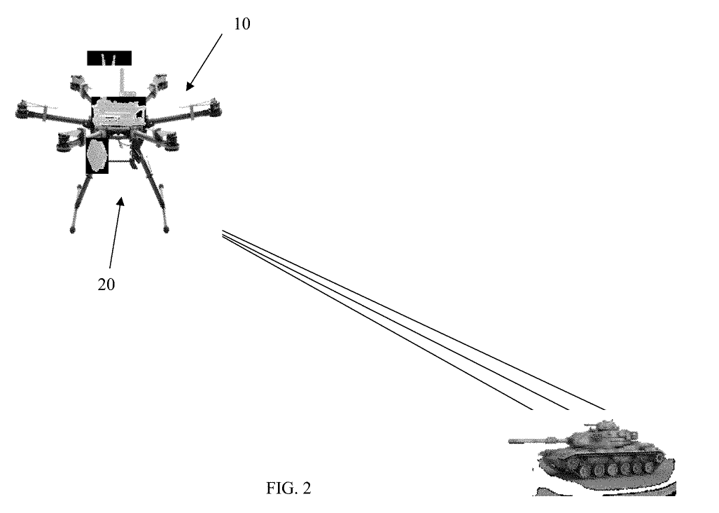

Referring to FIG. 2, one embodiment of the present disclosure used in a long range application is shown. More specifically, an unmanned vehicle 10, here a drone, comprises one embodiment of the system of the present disclosure 20 used for long range scanning and target detection. In certain embodiments, the DLP scanning provides target ID and supplements the poor long-wave infrared (LWIR) resolution present on small drones. In one embodiment, a LWIR sensor used at altitude provides limited resolution. In one example system the DLP at 1000 meters collects about 140 data points across a target in only 46 milliseconds; providing a 3D target image to supplement the LWIR data. In some cases, the scan rates for the system are about 3K to 10K pulse/second.

In certain embodiments of the system a 3D image ID is provided by measuring the length and width to within 0.4 meters and the height to within about 0.2 meters. In one example, a 30° FOV provides for 0.81 mrads resolution and feature detection to about 0.40 meters while at 500 ft altitude. Still referring to FIG. 2, a 100 μJ pulse laser provides about 140 range data points and can detect a tank, or other 3D target, at 500 meters (at night) with about 0.3 to about 0.4 meter resolution and 0.2 m range depth. The variability of the DLP array allows for adjustment of image resolution to account for range, weather conditions, and attitude of the target. Coupled with a learning AI system, the unmanned vehicle can offer superior tactical flexibility in the operational environment.

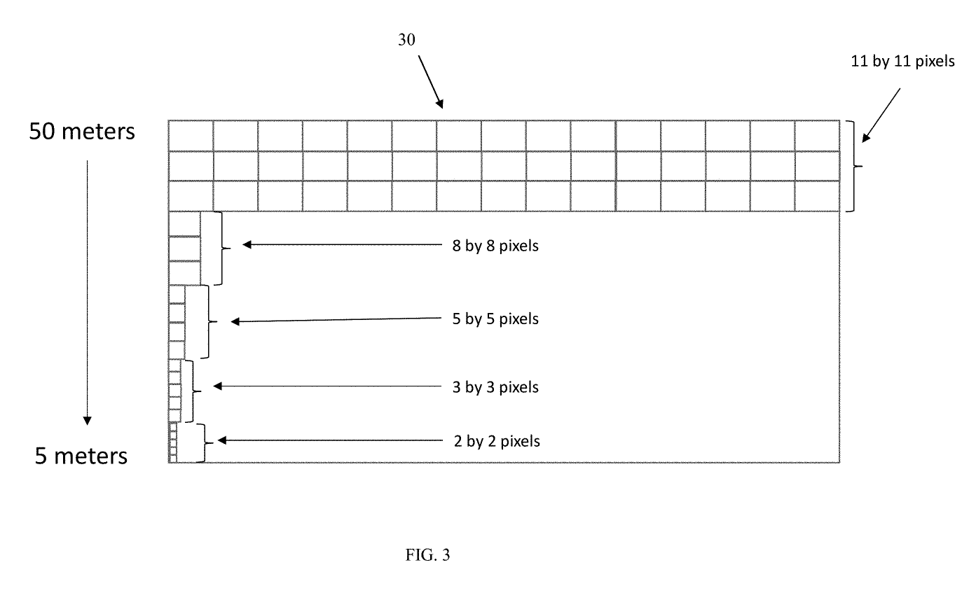

Referring to FIG. 3, resolution changes with range according to the principles of the present disclosure are shown. More particularly, the image shows that with larger ranges, e.g., 50 meters, the DLP can utilize larger pixel groupings e.g., 11×11 pixels to provide resolution on the order of about 50 cm. At closer range, e.g., 5 meters, the DLP can utilize smaller pixel groupings e.g., 2×2 pixels to provide resolution on the order of about 1 cm. As can be seen in the figure, the DLP can adjust the groupings to accommodate different resolutions that are more applicable to different distance ranges. In some cases, the pixel groupings, may include, but are not limited to 2×2, 3×3, 5×5, 8×8, 11×11, and the like. In certain embodiments, the system can adjust “on the fly” to provide the data needed to navigate the vehicle. In some cases, a portrait view may be an ideal view for increased elevation coverage. In this example, a series of varied horizontal scans provides a gradient of different resolutions to map the scene a close proximity (finer detail) and at farther distances (gross features).

Still referring to FIG. 3, in certain embodiments, the particular application may benefit from having the DLP use a first line sweep at a first angle and resolution (e.g., 11×11 pixels); a second line sweep at a second angle and resolution (e.g., 8×8 pixels); a third line sweep at a third angle and resolution (e.g., 5×5 pixels), and so on. In other embodiments, the DLP array can use a certain percentage of the pixels in the array for a line scan and another percentage of the pixels in the array for object tracking. In one case, 20% could be used for a line scan and 80% could be used for object tracking. The options available to the system are wide-ranging due to the use of the DLP array. In some cases, the resolution needed may not be particularly high (e.g., walking a flat road), and in other cases it may be important to have granular details (e.g., walking/running on a bumpy road). In some cases, if the unmanned vehicle is not moving very fast then the DLP can revisit points every few seconds. If, on the other hand, the unmanned vehicle is moving faster then it may be beneficial to revisit the data points every tenth of a second or less. In addition, once the 3D scene is generated, the tracking of the scene relative to the attitude of the vehicle can utilize the processor to implement interlaced scan patterns where long and short range objects can be scanned in one pulse, allowing the receiver to detect a long and short range pulse; thereby conserving laser energy.

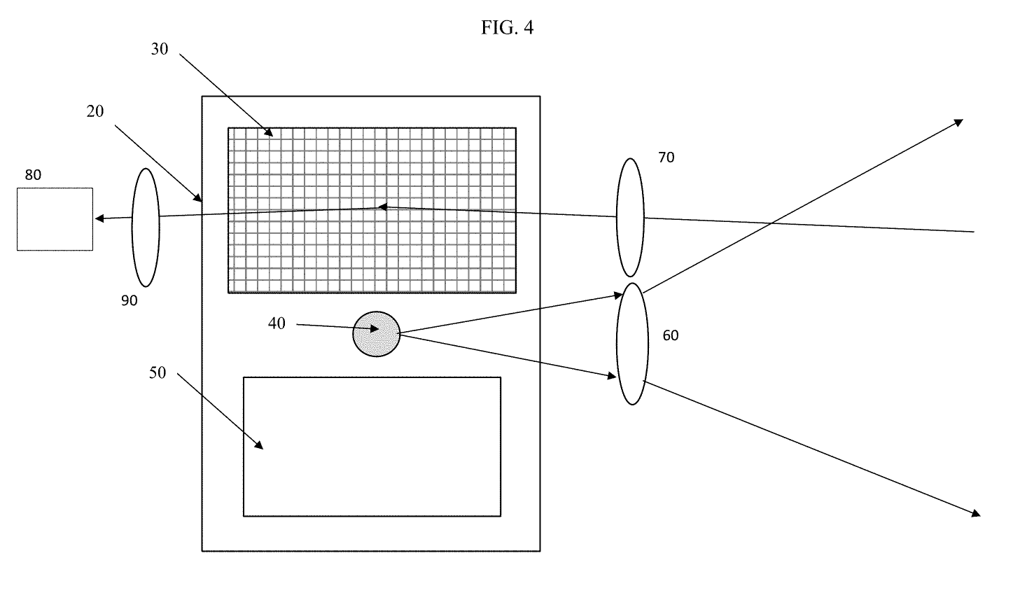

Referring to FIG. 4, a diagrammatic view of one embodiment of the system of the present disclosure is shown. More specifically, a package 20 comprising the digital light processing and light detection and ranging system for guided autonomous vehicles is shown. There, a DLP array 30 is shown along with a laser transmitter 40. Additionally, the unit may comprise processing and power modules 50. The laser energy is distributed over the scene area by lens assembly 60. The receiver energy is collected at lens assembly 70 and focused onto the DLP mirror array 30 where the selected region of mirrors are activated to reflect the energy directly into the receiver 80 using a condensing lens 90. The processor 50 then determines the optimal DLP image (between on and off mirror states) that generates the most effective scan pattern.

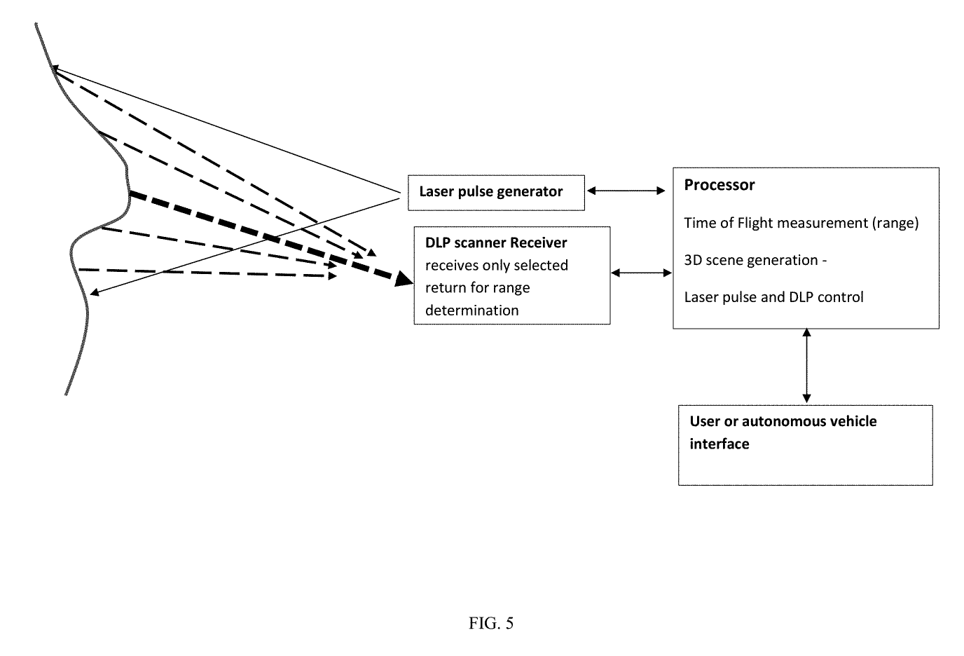

Referring to FIG. 5, a diagram of one embodiment of the method of the present disclosure is shown. More specifically, the system generates laser pulses and the associated DLP receiver uses particular scan patterns to construct a 3D image of the scene. In one embodiment, the process generates an initial assessment with a few horizontal line scans to determine image roughness and relative distances. By adapting the scan to add detail in areas of complexity and relative proximity to the vehicle the processor intermixes line scans and area concentration mapping, as needed, for the particular vehicle mission. The process starts with the processor setting the laser on high pulse repetition frequency (PRF) to form a simple image, and then adds detail, as required, and as tasked by the processor. The data collected by the system can then be fed to an autonomous vehicle interface for use in navigation and/or the data can be fed to a user for use in a tactical situation where target identification and target location are critical to mission success.

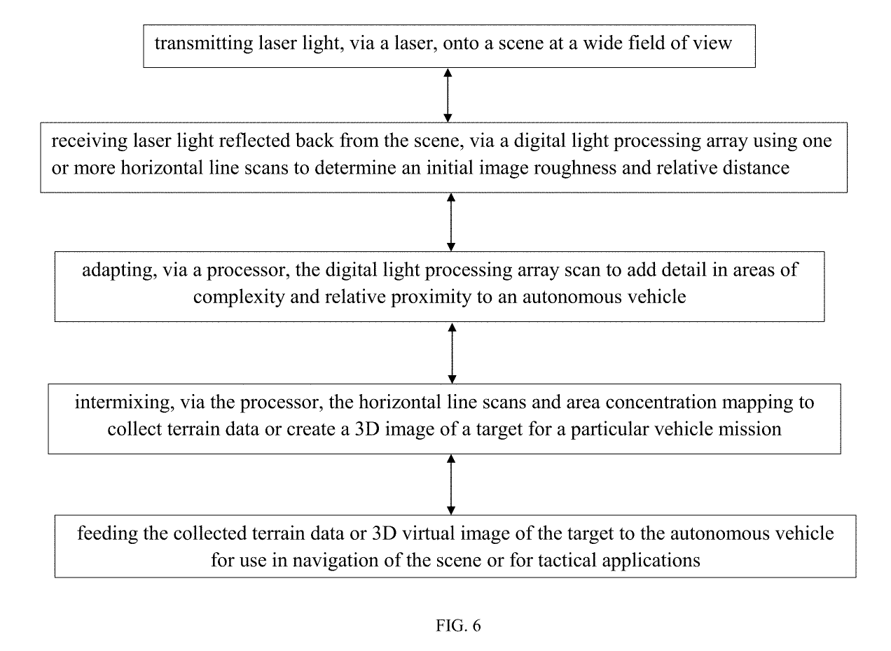

Referring to FIG. 6, a flow chart of one embodiment of the method of the present disclosure is shown. More specifically, laser light is transmitted, via a laser, onto a scene at a wide field of view. In some cases, the field of view is about 40 to about 60 degrees. A a digital light processing array receives the laser light reflected back from the scene, using one or more horizontal line scans to determine an initial image roughness and relative distances. A processor adapts the digital light processing array scan patterns to add detail in areas of complexity and relative proximity to an autonomous vehicle and/or to track a target. The processor intermixes horizontal line scans and area concentration mapping, as needed, for the particular vehicle mission. The data is then fed to the autonomous vehicle for use in navigation and/or to a user for use in target identification and tracking.

It will be appreciated from the above that the system may be implemented as computer software, which may be supplied on a storage medium or via a transmission medium such as a local-area network or a wide-area network, such as the Internet. It is to be further understood that, because some of the constituent system components and method steps depicted in the accompanying Figures can be implemented in software, the actual connections between the systems components (or the process steps) may differ depending upon the manner in which the present invention is programmed. Given the teachings of the present invention provided herein, one of ordinary skill in the related art will be able to contemplate these and similar implementations or configurations of the present invention.

It is to be understood that the present invention can be implemented in various forms of hardware, software, firmware, special purpose processes, or a combination thereof. In one embodiment, the present invention can be implemented in software as an application program tangible embodied on a computer readable program storage device. The application program can be uploaded to, and executed by, a machine comprising any suitable architecture.

While various embodiments of the present invention have been described in detail, it is apparent that various modifications and alterations of those embodiments will occur to and be readily apparent to those skilled in the art. However, it is to be expressly understood that such modifications and alterations are within the scope and spirit of the present invention, as set forth in the appended claims. Further, the invention(s) described herein is capable of other embodiments and of being practiced or of being carried out in various other related ways. In addition, it is to be understood that the phraseology and terminology used herein is for the purpose of description and should not be regarded as limiting. The use of “including,” “comprising,” or “having,” and variations thereof herein, is meant to encompass the items listed thereafter and equivalents thereof as well as additional items while only the terms “consisting of” and “consisting only of” are to be construed in a limitative sense.

The foregoing description of the embodiments of the present disclosure has been presented for the purposes of illustration and description. It is not intended to be exhaustive or to limit the present disclosure to the precise form disclosed. Many modifications and variations are possible in light of this disclosure. It is intended that the scope of the present disclosure be limited not by this detailed description, but rather by the claims appended hereto.

A number of implementations have been described. Nevertheless, it will be understood that various modifications may be made without departing from the scope of the disclosure. Although operations are depicted in the drawings in a particular order, this should not be understood as requiring that such operations be performed in the particular order shown or in sequential order, or that all illustrated operations be performed, to achieve desirable results.

While the principles of the disclosure have been described herein, it is to be understood by those skilled in the art that this description is made only by way of example and not as a limitation as to the scope of the disclosure. Other embodiments are contemplated within the scope of the present disclosure in addition to the exemplary embodiments shown and described herein. Modifications and substitutions by one of ordinary skill in the art are considered to be within the scope of the present disclosure.

What is claimed:

1. A digital light processing and light detection and ranging system for guiding autonomous vehicles, comprising
a laser transmitter for transmitting a laser pulse having a field of view;
a digital light processing array having a plurality of micro-mirrors, and each of the plurality of micro-mirrors having both an on position and an off position, wherein the micro-mirrors are in the on position when they receive laser light reflected back from an object;
a detector element for receiving light reflected by the plurality of micro-mirrors of the digital light processing array when the plurality of micro-mirrors are in the on position;
an optical condenser arrangement located between the digital light processing array and the detector element;
an analog/digital converter coupled to the detector element for processing signals detected by the detector element; and
a navigation processor configured to assess the terrain roughness, the terrain complexity and the terrain depth to determine the best course given limits of the autonomous vehicle.

2. The digital light processing and light detection and ranging system for guiding autonomous vehicles of claim 1, wherein the laser pulse comprises visible, near infrared, and short wave infrared bands radiating between 0.5 and 30 KHz.

3. The digital light processing and light detection and ranging system for guiding autonomous vehicles of claim 1, wherein the laser pulse operates at 5 to 100 μJ.

4. The digital light processing and light detection and ranging system for guiding autonomous vehicles of claim 1, wherein the field of view of the laser ranges from about 2 degrees to about 70 degrees.

5. The digital light processing and light detection and ranging system for guiding autonomous vehicles of claim 1, wherein the digital light processing array ranges from video graphics array format to high definition format and operates from 0.5 to 30 KHz in the visible, near infrared, and/or short wave infrared bands.

6. The digital light processing and light detection and ranging system for guiding autonomous vehicles of claim 1, wherein the autonomous vehicle is selected from the group consisting of ground, air, or marine.

7. A method of intermixing line scans and complex geometry mapping for use with spatial filtering and time interlacing to produce both near and far sampling over a scene of interest using decomposition and reconstruction, comprising
providing a digital light processing and light detection and ranging system, comprising
a laser transmitter for transmitting a laser pulse having a field of view;
a digital light processing array having a plurality of micro-mirrors, and each of the plurality of micro-mirrors having both an on position and an off position, wherein the micro-mirrors are in the on position when they receive laser light reflected back from an object;
a detector element for receiving light reflected by the plurality of micro-mirrors of the digital light processing array when the plurality of micro-mirrors are in the on position;
an optical condenser arrangement located between the digital light processing array and the detector element;
an analog/digital converter coupled to the detector element for processing signals detected by the detector element; and
a navigation processor configured to assess the terrain roughness, the terrain complexity, and the terrain depth to determine the best course given the limits of an autonomous vehicle;
transmitting laser light, via the laser, onto a scene;
receiving laser light reflected back from the scene, via the digital light processing array using one or more horizontal line scans to determine the image roughness and relative distances;
adapting, via the processor, the digital light processing array scanning pattern to add detail in areas of complexity and relative proximity to the autonomous vehicle;
intermixing, via the processor, the horizontal line scans and area concentration mapping, as needed, to collect terrain data for the particular vehicle mission; and
feeding the collected terrain data to the autonomous vehicle for use in navigation of the scene.

8. The method for guiding autonomous vehicles of claim 7, wherein the laser pulse comprises visible, near infrared, and/or short wave infrared bands radiating between 0.5 to 30 KHz.

9. The method for guiding autonomous vehicles of claim 7, wherein the laser pulse operates at 5 to 100 μJ.

10. The method for guiding autonomous vehicles of claim 7, wherein the field of view ranges from about 2 degrees to about 70 degrees.

11. The method for guiding autonomous vehicles of claim 7, wherein the digital light processing array ranges from video graphics array format to high definition format and operates from 0.5 to 30 KHz in the visible, near infrared and/or short wave infrared bands.

12. The method for guiding autonomous vehicles of claim 7, wherein the autonomous vehicle is selected form the group consisting of ground, air, and marine.

13. A method of identifying targets by measuring a target depth in 3D space, comprising
transmitting laser light, via a laser, onto a scene at a field of view of about 40 to 60 degrees;
receiving laser light reflected back from the scene, via a digital light processing array using one or more horizontal line scans to determine an image roughness and relative distance;
adapting, via a processor, the digital light processing array scanning pattern to add detail in areas of complexity and relative proximity to an autonomous vehicle;
intermixing, via the processor, the horizontal line scans and area concentration mapping to create a 3D virtual image of a target; and
feeding the 3D virtual image of the target to a user for use in tactical applications.

14. The method of identifying targets of claim 13, wherein the laser pulse comprises visible, near infrared, and/or short wave infrared bands radiating between 0.5 and 30 KHz.

15. The method of identifying targets of claim 13, wherein the laser pulse operates at 5 to 100 μJ.

16. The method of identifying targets of claim 13, wherein the field of view ranges from about 2 degrees to about 70 degrees.

17. The method of identifying targets of claim 13, wherein the digital light processing array ranges from video graphics array format to high definition format and operates from 0.5 to 30 KHz in the visible, near infrared and/or short wave infrared bands.

18. The method of identifying targets of claim 13, wherein the autonomous vehicle is selected from the group consisting of ground, air, and marine.
